(19) United States
(12) Patent Application Publication
(10) Pub. No.: US 2026/0024028 A1
(43) Pub. Date: Jan. 22, 2026

(54) SYSTEMS, METHODS, AND DEVICES FOR PREDICTING WILDFIRE BEHAVIOUR IN REAL TIME

(71) Applicant: SenseNet Inc., Vancouver (CA)

(72) Inventors: Shahab Bahrami, Vancouver (CA); Hamed Noori, Vancouver (CA)

(21) Appl. No.: 18/778,396

(22) Filed: Jul. 19, 2024

(51) Int. Cl. G06Q 10/04; G01D 21/02; G06F 16/29; G06N 20/00; H04W 4/90

(52) U.S. Cl. CPC G06Q 10/04; G01D 21/02; G06F 16/29; G06N 20/00; H04W 4/90

(57) ABSTRACT

A system, method, and server for wildfire behaviour in real time are provided. The system includes sensor subsystems for measuring geographical data and environmental data of a first area and an analysis server, the analysis server including a memory for storing environmental dynamics data and historical data, a simulation module for generating simulation data pertaining to the behaviour responsive to receiving the geographical data, the environmental data, and/or the environmental dynamics data or the historical data, a prediction module for generating a prediction model for predicting the behaviour by incorporating the geographical data, the environmental data, the environmental dynamics data, and/or the historical data into the prediction model, and an artificial intelligence engine configured to enable the prediction module to answer specific questions and learn from the simulation data and/or the predicted behaviour. Output of the AI engine is stored at the analysis server to iteratively improve the analysis server.

### TECHNICAL FIELD

The following relates generally to wildfire behaviour prediction in real time, and more particularly to systems, methods, and devices for predicting wildfire behaviour in real time according to integrated environmental data as analyzed by artificial intelligence.

### INTRODUCTION

Wildfires pose numerous dangers to human life, to the environment, and to property. Wildfires may be deadly for both humans and animals alike. Wildfires present particular risks to people of becoming trapped by rapidly moving flames or succumbing to smoke inhalation and to wildlife of not being able to escape or find suitable habitats thereafter. Wildfires may cause extensive damage to residential and commercial properties, infrastructure, and agricultural lands, resulting in significant financial losses for individuals, businesses, and governments.

Significant environmental devastation may also result from wildfires. Such devastation includes damage to forests, grasslands, and other ecosystems due to the loss of vegetation. Such loss of vegetation leads to soil erosion, reduced water quality, and an increased risk for landslides and flooding in affected areas. Smoke from wildfires may significantly reduce air quality, leading to respiratory problems and other health concerns for people and animals alike. Fine particulate matter (PM_{2.5}) and other pollutants are able to travel long distances, impacting air quality even far away from where wildfires have occurred. Furthermore, wildfires release large amounts of carbon dioxide (CO₂) and other greenhouse gases into the atmosphere, contributing to climate change.

When wildfires occur, the environment surrounding the wildfire may be drastically changed in a short period of time resulting in micro-climates such that models that depend for their validity on pre-wildfire data may no longer be accurate. It is highly desirable to sense and integrated sensed data pertaining to the micro-climates in order to make accurate predictions in real time as to the behaviour of a wildfire, e.g., whether and where it will spread, the spread rate, the direction, the size. Such predictions may enable timely evacuation and may save countless lives. Such predictions may also enable mitigating damage to the environment and to property and infrastructure. Furthermore, firefighting authorities may be able to allocate resources more effectively to where they are most needed. Such allocation may result in a more efficient use of personnel, equipment and financial resources and may help preserve human life.

Conventional wildfire surveillance systems have limitations and are unable to incorporate data pertaining to such microclimates in their models in real time. Such known wildfire surveillance systems are therefore limited in the accuracy and timeliness of predictions as to wildfire behaviour once a wildfire starts. These systems may not effectively integrate diverse data types or provide real-time analysis, which is critical for responding to rapidly changing conditions.

Wildfire behaviour prediction plays a crucial role in wildfire management and mitigation. Accurate and timely predictions help save lives, property, and natural resources. They enable better resource allocation, early warnings, and more effective firefighting strategies. However, many wildfire prediction systems depend on historical data, which may not accurately represent the current conditions on the ground. The absence of real-time monitoring makes it difficult to quickly adapt to changing conditions and make accurate predictions.

Accordingly, networks, methods, and devices are desired that overcome one or more disadvantages associated with existing wildfire detection, monitoring, and prediction systems.

### SUMMARY

A system for predicting behaviour of a wildfire in real time is provided. The system includes a first sensor subsystem for measuring geographical data of a first area, the first sensor subsystem including one or more data collecting devices, a second sensor subsystem for measuring environmental data of the first area, the second sensor subsystem including one or more data collecting devices, and an analysis server including a memory for storing environmental dynamics data and historical data, a simulation module for generating simulation data pertaining to the behaviour of the wildfire responsive to receiving the geographical data from the first sensor subsystem, the environmental data from the second subsystem, and/or the environmental dynamics data or the historical data, a prediction module for generating a prediction model for predicting the behaviour of the wildfire at a future or hypothetical point in time by incorporating the geographical data, the environmental data, the environmental dynamics data, and/or the historical data into the prediction model, and an artificial intelligence (AI) engine configured to enable the prediction module to answer specific questions and learn from the simulation data and/or the predicted behaviour of the wildfire. Output of the AI engine is stored at the analysis server to iteratively improve the analysis server.

The first area may be an area in which the wildfire has occurred.

The environmental dynamics data may include wind data including wind speed perturbations, temperature data, precipitation data, and sunshine intensity data.

The historical data may include ignition points selected based on proximity to high-risk areas including power lines, railways, villages, roads, and campsites.

The simulation data may include one or more simulated behaviours of the wildfire at the future or hypothetical point in time.

The one or more simulated behaviours may include the wildfire spreading to a second area adjacent the first area.

The prediction model may generate a specific prediction as to the behaviour of the wildfire at the future or hypothetical point in time.

The specific prediction may include a prediction as to any one or more of characteristics or microdynamics of the wildfire, new fire spots of the wildfire, areas at higher risk of another wildfire, whether and how the wildfire spreads at the future or hypothetical point in time, and the efficacy of one or more strategies for mitigating or extinguishing the wildfire or preventing wildfires.

The analysis server may be configured to detect new fire spots through abnormal changes detected in the geographical data or the environmental data.

Each data collecting device may include a sensor assembly. The sensor assembly may include a plurality of sensors configured to detect the environmental data, the environmental data relating to any one or more of carbon dioxide, carbon monoxide, nitrogen dioxide, temperature, and humidity. The sensor assembly may include a filter configured to improve measurement accuracy, the filter configured as any one or more of a bandpass filter, a neutral density filter, a chemical filter, and a particulate filter.

Each data collecting device may include a wireless communication module, and the wireless communication module may be configured to operate in any one of a plurality of operation modes including a LoRa end-node, a LoRaWAN end-node, a LoRa repeater mode, and a LoRa to LoRaWAN mode based on the received network protocol of another data collecting device.

Each data collecting device may include a power supply assembly configured to provide electrical power to the respective data collecting device, the power supply assembly including a power source and a power management circuit, the power source including a rechargeable battery and a non-rechargeable battery, the rechargeable battery serving as a first power source until an energy level of the rechargeable battery reaches a predetermined limit according to the power management circuit, and the non-rechargeable battery serving as a second power source when the energy level is at the predetermined limit.

Each data collecting device may be configured to automatically select a network protocol from a plurality of network protocols based on a location of the data collecting device and/or a received network protocol received from another data collecting device.

A method for predicting behaviour of a wildfire in real time is provided. The method includes measuring, with a first sensor subsystem, geographical data of a first area, the first sensor subsystem including one or more data collecting devices, measuring, with a second sensor subsystem, environmental data of the first area, the second sensor subsystem including one or more data collecting devices, storing environmental dynamics data and historical data, generating simulation data pertaining to the behaviour of the wildfire based at least in part on the geographical data from the first sensor subsystem, the environmental data from the second subsystem, and/or the environmental dynamics data or the historical data, generating a prediction model for predicting the behaviour of the wildfire at a future or hypothetical point in time by incorporating the geographical data, the environmental data, the environmental dynamics data, and/or the historical data into the prediction model, and providing an artificial intelligence (AI) engine configured to enable the prediction module to answer specific questions and learn from the simulation data and/or the predicted behaviour of the wildfire. Output of the AI engine is used to iteratively improve the simulation data and/or the prediction model.

The first area may be an area in which the wildfire has occurred.

The environmental dynamics data may include wind data including wind speed perturbations, temperature data, precipitation data, and sunshine intensity data.

The historical data may include ignition points selected based on proximity to high-risk areas including power lines, railways, villages, roads, and campsites.

The simulation data may include one or more simulated behaviours of the wildfire at the future or hypothetical point in time.

The one or more simulated behaviours may include the wildfire spreading to a second area adjacent the first area.

The prediction model may generate a specific prediction as to the behaviour of the wildfire at the future or hypothetical point in time.

The specific prediction may include a prediction as to any one or more of characteristics or microdynamics of the wildfire, new fire spots of the wildfire, areas at higher risk of another wildfire, whether and how the wildfire spreads at the future or hypothetical point in time, and the efficacy of one or more strategies for mitigating or extinguishing the wildfire or preventing wildfires.

The method may further include detecting new fire spots through abnormal changes detected in the geographical data or the environmental data.

Each data collecting device may include a sensor assembly, the sensor assembly including a plurality of sensors configured to detect the environmental data, the environmental data relating to any one or more of carbon dioxide, carbon monoxide, nitrogen dioxide, temperature, and humidity, the sensor assembly including a filter configured to improve measurement accuracy, the filter configured as any one or more of a bandpass filter, a neutral density filter, a chemical filter, and a particulate filter.

Each data collecting device may include a wireless communication module, the wireless communication module configured to operate in any one of a plurality of operation modes including a LoRa end-node, a LoRaWAN end-node, a LoRa repeater mode, and a LoRa to LoRaWAN mode based on the received network protocol of another data collecting device.

Each data collecting device may include a power supply assembly configured to provide electrical power to the respective data collecting device, the power supply assembly including a power source and a power management circuit, the power source including a rechargeable battery and a non-rechargeable battery, the rechargeable battery serving as a first power source until an energy level of the rechargeable battery reaches a predetermined limit according to the power management circuit, and the non-rechargeable battery serving as a second power source when the energy level is at the predetermined limit.

The method may further include selecting automatically, by each data collecting device, a network protocol from a plurality of network protocols based on a location of the data collecting device and/or a received network protocol received from another data collecting device.

An analysis server for predicting behaviour of a wildfire in real time is provided. The server receives geographical data of a first area from a first sensor subsystem including one or more data collecting devices and receives environmental data of the first area from a second sensor subsystem including one or more data collecting devices. The server includes a memory for storing environmental dynamics data and historical data, a simulation module for generating simulation data pertaining to the behaviour of the wildfire responsive to receiving the geographical data from the first sensor subsystem, the environmental data from the second subsystem, and/or the environmental dynamics data or the historical data, a prediction module for generating a prediction model for predicting the behaviour of the wildfire at a future or hypothetical point in time by incorporating the geographical data, the environmental data, the environmental dynamics data, and/or the historical data into the prediction model, and an artificial intelligence (AI) engine configured to enable the prediction module to answer specific questions and learn from the simulation data and/or the predicted behaviour of the wildfire. Output of the AI engine is stored at the analysis server to iteratively improve the analysis server.

The first area may be an area in which the wildfire has occurred.

The environmental dynamics data may include wind data including wind speed perturbations, temperature data, precipitation data, and sunshine intensity data.

The historical data may include ignition points selected based on proximity to high-risk areas including power lines, railways, villages, roads, and campsites.

The simulation data may include one or more simulated behaviours of the wildfire at the future or hypothetical point in time.

The one or more simulated behaviours may include the wildfire spreading to a second area adjacent the first area.

The prediction model may generate a specific prediction as to the behaviour of the wildfire at the future or hypothetical point in time.

The specific prediction may include a prediction as to any one or more of characteristics or microdynamics of the wildfire, new fire spots of the wildfire, areas at higher risk of another wildfire, whether and how the wildfire spreads at the future or hypothetical point in time, and the efficacy of one or more strategies for mitigating or extinguishing the wildfire or preventing wildfires.

The analysis server may be configured to detect new fire spots through abnormal changes detected in the geographical data or the environmental data.

Each data collecting device may include a sensor assembly, the sensor assembly including a plurality of sensors configured to detect the environmental data, the environmental data relating to any one or more of carbon dioxide, carbon monoxide, nitrogen dioxide, temperature, and humidity. The sensor assembly may include a filter configured to improve measurement accuracy, the filter configured as any one or more of a bandpass filter, a neutral density filter, a chemical filter, and a particulate filter.

Each data collecting device may include a wireless communication module, and the wireless communication module may be configured to operate in any one of a plurality of operation modes including a LoRa end-node, a LoRaWAN end-node, a LoRa repeater mode, and a LoRa to LoRaWAN mode based on the received network protocol of another data collecting device.

Each data collecting device may include a power supply assembly configured to provide electrical power to the respective data collecting device, the power supply assembly including a power source and a power management circuit, the power source including a rechargeable battery and a non-rechargeable battery, the rechargeable battery serving as a first power source until an energy level of the rechargeable battery reaches a predetermined limit according to the power management circuit, and the non-rechargeable battery serving as a second power source when the energy level is at the predetermined limit.

Each data collecting device may be configured to automatically select a network protocol from a plurality of network protocols based on a location of the data collecting device and/or a received network protocol received from another data collecting device.

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of systems, methods, and devices of the present specification. In the drawings:

FIG. 1 is a schematic diagram illustrating a system for predicting wildfire behaviour in real time, according to an embodiment;

FIG. 2 is a simplified block diagram of components of a device, according to an embodiment;

FIG. 3 is a block diagram of a data collecting device for predicting wildfire behaviour in real time, according to an embodiment;

FIG. 4 is a block diagram of a system for predicting wildfire behaviour in real time, according to an embodiment; and

FIG. 5 is a flow diagram of a method for predicting wildfire behaviour in real time, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, personal computer, cloud-based program or system, laptop, personal data assistant, cellular telephone, smartphone, or tablet device.

Each program is preferably implemented in a high-level procedural or object-oriented programming and/or scripting language to communicate with a computer system. However, the programs may be implemented in assembly or machine language, if desired. In any case, the language may be a compiled or interpreted language. Each such computer program is preferably stored on a storage medium or a device readable by a general- or special-purpose programmable computer for configuring and operating the computer when the storage medium or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms, or the like may be described (in the disclosure and/or in the claims) in a sequential order, such processes, methods, and algorithms may be configured to work in alternate orders. Accordingly, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device or article (whether or not they cooperate) may be used in place of a single device or article. Similarly, where more than one device or article is described herein (whether or not they cooperate), it will be readily apparent that a single device or article may be used in place of the more than one device or article.

The following relates generally to wildfire behaviour prediction in real time, and more particularly to systems, methods, and devices for predicting wildfire behaviour in real time according to integrated geographical and environmental data as analyzed by artificial intelligence.

Systems for wildfire behaviour prediction are essential tools for forest and wildlife management agencies. Predicting wildfire behaviour in real time according to data sensed in or on the micro-climate of the wildfire advantageously results in more accurate and immediate predictions, thereby advantageously minimizing damage to ecosystems, protecting endangered species, and preserving human life.

The use of artificial intelligence to enable real-time prediction of wildfire behaviour further helps maximize resource allocation for firefighting operations, enabling authorities to prioritize their response and deploy personnel and equipment strategically. Such allocation ensures that efforts are focused on the most critical areas, preventing the spread of wildfires and minimizing overall costs associated with suppression efforts.

The systems, methods, and devices of the present disclosure predict wildfire behavior by employing AI in conjunction with real-time environmental and geographical data gathered from a network of ground sensors. The system of the present disclosure collects detailed measurements on variables such as CO₂, CO, NOₓ, VOC, temperature, humidity, and pressure, alongside extensive geographical insights including topography, slope, and vegetation characteristics. This approach enables high-resolution, real-time insights into wildfire dynamics, enabling a prediction model to predict fire spread, direction, and intensity with high accuracy and speed. The systems, methods, and devices of the present disclosure address the limitations of current environmental data from weather stations, which often lack precision in the rapidly changing conditions of a wildfire, thereby failing to accurately predict the microdynamics of such fires. The real-time environmental and geographical data gathered from the foregoing network of ground sensors advantageously permit adaptation to the unpredictable environmental changes that large-scale wildfires induce in order to significantly improve wildfire behavior prediction.

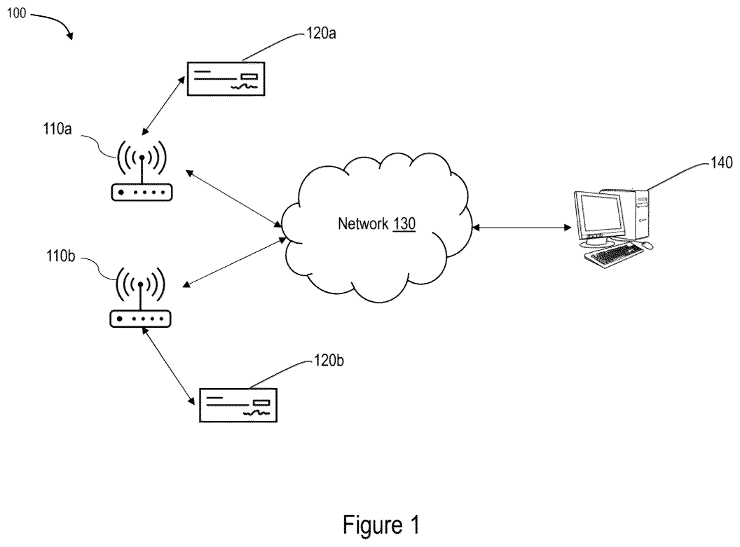

Referring now to FIG. 1, shown therein is a schematic diagram illustrating a system 100 for predicting wildfire behaviour in real time, according to an embodiment.

The system 100 includes a plurality of sensor subsystems 110a, 110b (collectively referred to as the sensor subsystems 110 and generically referred to as the sensor subsystem 110) each including one or more sensors 120a, 120b, respectively (collectively referred to as the sensors 120 and generically referred to as the sensor 120). It will be appreciated that the system 100 may include more sensor subsystems 110, and each sensor subsystem 110 may include more sensors 120. The sensors 120 may be ground sensors.

The subsystems 110 may include servers or other devices for receiving and transmitting data sensed by the sensors 120. Such servers or other devices may further process, aggregate, or analyze the sensed data received from the sensors 120 before further transmitting such data.

The sensor subsystem 110a measures extensive geographical data of the area monitored by the system 100. The sensors 120a are configured to measure one or more of topography, slope, elevation, vegetation type, soil moisture, dead fuel moisture, canopy density, and canopy height.

The sensor subsystem 110b measures high-resolution environmental data. The sensors 120b are configured to measure one or more of the concentration of one or more of CO₂, CO, NOₓ, VOC, CH₄, O₃, H₂, PM₁, PM_{2.5}, PM₅, PM₁₀; temperature; humidity; and air pressure. The sensors 120b may perform measurements every 30 seconds to 5 minutes to provide a comprehensive data foundation for analysis.

The sensor subsystems 110 perform high-resolution measurement of the foregoing data in real time in order to enable real-time insights into wildfire dynamics.

The system 100 further includes a network 130 for providing communication between the components of the system 100.

The system 110 further includes an analysis server 140 for performing analysis and predicting wildfire behaviour in real time. The analysis server 140 receives the measurements sensed by the sensor subsystems 110 and applies artificial intelligence to the measurements to make specific predictions.

Synthesizing the data from both subsystems 110, the analysis server 140 predicts spread rate, direction, fireline intensity, and the development of real-time isochrones with respect to wildfires. Such predictions enable dynamic and accurate forecasting of wildfire behaviour in real time.

The high-resolution environmental data measured by the sensor subsystem 110b and received, via the network 130, at the analysis server 140 may be particularly advantageous in allowing the analysis server 140 to understand and predict the microdynamics of wildfires, which include small-scale variation in fire behaviour (e.g., how one wildfire is behaving differently to a previously measured wildfire) that are not detectable by conventional methods that use low-resolution data and inaccurate weather station data. The analysis server 140 is configured to process such high-resolution data provided by the sensor subsystem 110b in order to make predictions that are both more accurate than conventional methods and provided in real time.

The analysis server 140, and the artificial intelligence leveraged thereby, are advantageously able to learn and improve as the system 100 performs predictions. For example, the analysis server 140 is configured to detect new fire spots through abnormal changes in data sensed by the sensors 120, collected through the sensor subsystems 110, and provided to the analysis server 140 via the network 130. Because the analysis server 140 is configured to detect the new fire spots, predictions as to spread rate, direction, and fireline intensity of wildfires sensed by the system 100 may be continuously updated. As the analysis server 140 generates more predictions, the analysis server 140 becomes even more accurate and responsive. In particular, the use of real-time sensor data sensed by the sensor subsystems 110 enables the system 100 to predict changes in fireline intensity and the development of isochrones in short time intervals, such changes being critical in assessing and mitigating the potential damage and loss of life caused by wildfires.

In an embodiment, the sensors 120 detect the new fire spots.

The sensors 120 measure active fire perimeters in real time. Such measured active fire perimeters are incorporated into the analysis performed at the analysis server 140, including analyzing the current extent of wildfires, which enhances the capability of the server 140 to accurately forecast fire spread and behaviour by considering the immediate boundaries and characteristics of ongoing fires. Further predictions as to active fire perimeters are generated by the analysis server 140. Such further predictions may be supplied as input to the analysis server 140 to further improve and generate predictions.

The analysis server 140 is further configured to generate and store simulations of wildfire behaviour to compute the risk of a wildfire and further predict behaviour of the wildfire in specific areas. The analysis server 140 generates the simulations by leveraging historical environmental data. Such historical environmental data may be or may have been previously sensed by the sensor subsystem 110b or may be stored on the analysis server 140 or otherwise provided to the analysis server 140. The analysis server 140 generates the simulations by further leveraging geographical data. Such geographical data is sensed by the sensor subsystem 110a.

In generating and storing the simulations of wildfire behaviour, the analysis server 140 considers various ignition points selected based on proximity to high-risk areas such as power lines, railways, villages, roads, and campsites. Such selection of ignition points enables preemptive analysis and planning with respect to generating and storing the simulations, which allows for the identification of areas at a higher risk of wildfire ignition or spread. The foregoing further advantageously allows the analysis server 140 to study how wildfires start and spread, further improving the foregoing analysis. The foregoing further advantageously allows the analysis server 140 to simulate the implementation of targeted prevention and mitigation strategies.

The analysis server 140 incorporates environmental dynamics, such as wind speed perturbations, into predictions to account for the complex interaction between wildfires and their surrounding environment, improving the accuracy of prediction models, implemented at the analysis server 140, under varying conditions. Such environmental dynamics may be sensed by the sensor subsystem 110a, by the sensor subsystem 110b, and/or by further or other sensors 120. Such environmental dynamics may be provided to and/or stored by the analysis server 140 other than by the sensor subsystems 110 or the sensors 120.

Because wildfires may create their own microclimate (e.g., changing wind speed, air heating), incorporating environmental dynamics into the foregoing model and analysis allows the analysis server 140 to predict, in real time, where a wildfire is heading. Such real-time predictions are further improved by the foregoing collection and incorporation of geographical data and environmental data. Such geographical and environmental data may be used as secondary confirmation of real-time predictions and/or to improve the model implemented on the analysis server 140.

The application of artificial intelligence to the analysis server 140 advantageously provides for an adaptive learning capability on or to the analysis server. The analysis server 140 stores prediction models generated according to the foregoing. Such prediction models are iteratively improved by incorporating new data from active wildfires (e.g., as sensed by the sensor subsystems 110) and performing simulations and comparing outcomes with realized behaviour of the wildfires.

In an embodiment, data sensed by respective sensors 120 of a respective sensor subsystem 110 is merged at the respective sensor subsystem 110 such that the analysis server 140 receives data, via the network 130, from each respective sensor subsystem 110, e.g., as a continuous stream of data in real time, in batches.

In an embodiment, data sensed by respective sensors 120 of a respective sensor subsystem 110 is not merged at the respective sensor subsystem 110 such that the analysis server 140 receives data, via the network 130, from each respective sensor 110, e.g., as a plurality of continuous streams of data in real time, in batches.

In an embodiment, data sensed by respective sensors 120 of a respective sensor subsystem 110 is merged at the respective sensor subsystem 110 such that the analysis server 140 receives data, via the network 130, from each respective sensor subsystem 110, e.g., as a continuous stream of data in real time, in batches and further receives data, via the network 130, from each respective sensor 110, e.g., as a plurality of continuous streams of data in real time, in batches. Such merged data may be processed, aggregated, analyzed, or otherwise transformed before sending to the analysis server 140 via the network 130.

The geographical and/or environmental data may be transmitted over the network 130 using LoRa or LoRaWAN protocols. The sensors 120 may receive environmental data from neighboring sensors 120, such as a neighbouring sensor 120 using the LoRa or LoRaWAN protocol. Furthermore, the system 100 may include a receiving gateway configured as LoRaWAN gateway (not shown). Similarly, the sensors 120 may receive data from a LoRaWAN gateway. The data may be merged with data from the sensors 120 by the neighboring sensor 120. Each sensor 120 may select between eight frequency channels for transmission.

In an embodiment, the geographical and/or environmental data is transmitted on a LoRa 8-frequency channel. In another embodiment, the sensors 120 transmit data on multiple frequency channels to reduce interference and increase traffic handling capacity. The geographical and/or environmental data may be transmitted at a specific time period in time synchronization. The geographical and/or environmental data may be transmitted at a pre-defined time interval.

In an embodiment, the sensors 120 listen for, receive, and/or detect any communication via each of the 8 frequency channels. In an embodiment, a sensor 120 receives the geographical and/or environmental data from the other sensors 120 over the network 130. A low-power processing module in the sensor 120 may be configured to add the geographical and/or environmental data collected by the sensor 120 with the geographical and/or environmental data received from the other sensors 120 for transmitting the combined messages to the analysis server 140 via the network 130.

In an embodiment, when any of the sensors 120 receives one of the messages from a neighbouring sensor 120, the receiving sensor 120 adds data within the message for transmission during the next interval.

The network 130 may be configured as a wired, wireless, or hybrid (partially wired and wireless) network based on a type of communication links used for connecting devices. The wired network 130 may include physical cables, such as Ethernet™ cables, to connect components in the system 100. The wireless network 130 may include Wi-Fi™, Wi-Max™, radio-frequency identification (RFID), or Bluetooth™ functionality to connect components in the system 100. The hybrid network may include a combination of wired and wireless networks. Ethernet™ connections may be made between switches and routers (not shown) to provide wireless connections between the sensors 120 using wireless connections.

The network 130 may be a Low Power Wide Area Network (LPN) configured to include multiple network protocols such as LoRa and/or LoRaWAN protocols. A LoRa protocol is a network protocol that utilizes low-power and long-range wireless technology within a wireless spectrum. A LoRaWAN protocol is an open, cloud-based protocol that enables devices to communicate wirelessly with LoRa. The LoRaWAN protocol uses a LoRa modulation technique to enable low data rate communication over long distances while minimizing power consumption.

In an embodiment, the sensors 120 are organized or arranged according to a mesh topology. Advantageously, the mesh network topology provides higher resilience, decentralization, and scalability. In event of a failure or damage to one sensor 110, data may be transmitted to the analysis server 140 via the network 130 through alternative paths. Such data may include environmental data, i.e., data sensed by a device with respect to the external environment about the device, or geographical data, e.g., topography, slope, and vegetation characteristics. Furthermore, additional sensors 120 may be added to the system 100 without significant reconfiguration of the respective subsystem 110 or the network 130. According to an embodiment, the sensors 120 are optimized for reduced power consumption through time synchronization techniques. Techniques including duty cycling, time-slotted communication, coordinated sensing, power-efficient routing, and reduced idle listening may be used. The sensors 120 may be configured to activate data collection, reception, and transmission at predefined time schedules, and alternatively enter low-power inactive modes. Furthermore, each sensor 120 may be synchronized with other sensors 120 in the same subsystem 110 to provide coordinated sensing and power-efficient routing.

According to an embodiment, each sensor 120 connects to at least one other sensor 120 in the respective subsystem 110. The sensors 120 may be connected to other sensors 120 through the network 130 or directly. Because each sensor 120 connects to some or all of the other sensors 120 in the respective subsystem 110 and because at least some of the sensors 120 connect to the network 130, data from each sensor 120 is able to be sent to the network 130, whether directly (i.e., through direct transmission between the sensor 120 and the network 130) or indirectly (e.g., from a first sensor 120 within a respective subsystem 110 to a second sensor 120 within the respective subsystem 110).

According to an embodiment, each sensor 120 transmits geographical and/or environmental data to one or more other sensors 120 over the network 130. The sensor 120 may receive additional environmental data from the other sensors 120 over the network 130. The sensor 120 may be configured to merge the geographical and/or environmental data with the additional geographical and/or environmental data to form merged environmental data for transmitting over the network 130.

Various network protocols may be used to transmit data within or from the sensors 120. Preferably, low-powered network protocols including LoRa and LoRaWAN are used for transmission of the geographical and/or environmental data. In an embodiment, the merged geographical and/or environmental data includes geographical and/or environmental data as received from the other sensors 120.

The geographical and/or environmental data may relate to the presence or absence of a wildfire or the conditions for such a wildfire beginning or spreading in the vicinity of the sensor 120. The geographical and/or environmental data may be processed within the sensor 120. The processed geographical and/or environmental data may be transmitted over the network 130. The sensor 120 may transmit the geographical and/or environmental data over the network 130.

Each sensor subsystem 110 includes a plurality of sensors 120 for collecting the geographical data and/or the environmental data and a filter for protecting the plurality of sensors. The sensors may be configured as low-power data collecting devices for ultra-early wildfire detection. The sensors 120 may detect environmental conditions, such as the presence/absence of elements associated with fire such as carbon dioxide, carbon monoxide, nitrogen dioxide, temperature, and/or humidity. In an embodiment, the filter is removeable.

Each sensor 120 is configured to operate on a plurality of modes of operation or data transmission or network protocols. The sensor 120 may be configured to provide multiple modes of operation or data transmission or network protocols. The plurality of modes of operation may include LoRa end-node, LoRaWAN end-node, LoRa repeater mode, and LoRa to LoRaWAN mode. The modes of operation may represent various interoperability operations and utilities such as low battery consumption (LoRa), long-distance communication (LoRaWAN), extending communications (repeater mode), and interoperability between LoRa and LoRaWAN protocols, respectively. The sensor 120 may select the mode of operation or data transmission based on the location of the sensor 120 in the network 130. The sensor 120 may automatically select the mode based on the protocol through which data is received. For example, a LoRa mode may be selected on receiving a LoRa message or a LoRaWAN mode may be selected on receiving a LoRaWAN message.

In an embodiment, the system 100 includes a network gateway (not shown) configured as a LoRaWAN gateway. Where one of the sensors 120 receives only a LoRaWAN message from a LoRaWAN gateway (i.e., has a direct connection to the gateway), the sensor 120 selects a mode corresponding to a LoRaWAN end-node mode. Similarly, the sensor 120 may select the LoRaWAN end-node mode on receiving a LoRaWAN message from a neighboring sensor 120. In the LoRaWAN end-node mode, the sensor 120 collects sensor data from sensors (not shown) within the sensor 120 for transmission over the network 130 via a further LoRaWAN message.

If a first sensor 120 receives a LoRaWAN message from a LoRaWAN gateway and further receives a LoRa message from a second sensor 120, the first sensor 120 selects a LoRa to LoRaWAN mode. In the LoRa to LoRaWAN mode, the first sensor 120 receives data from the second sensor 120 via LoRa messages (i.e., receives data collected by the sensors of the second sensor 120) and merges data from the sensors of the first sensor 120 with the received data from the second sensor 120 for transmission over the network 130 in the LoRaWAN protocol to be received by the gateway. Merging the data may include aggregating the data of the first sensor 120 with the data of the second sensor 120 without altering or compressing the data of the first sensor 120 or the data of the second sensor 120. Merging the data may include pre-processing, altering, compressing, or post-processing the data of the first sensor 120 or the data of the second sensor 120.

If the first sensor 120 receives only LoRa messages from other sensors 120, the first sensor 120 selects a LoRa repeater mode. In the LoRa repeater mode, the first sensor 120 receives data from the other sensors 120 via LoRa messages (i.e., receives data collected by the sensors of the other sensors 120) and merges data from the sensors of the other sensors 120 with data from sensors of the first sensor 120 for transmission via LoRa messages over the network 130.

If one of the sensors 120 is located at an end of the network 130 away from any network gateway, then such sensor 120 may transmit data from its own sensors over LoRa messages to one or more other sensors 120. Further, if the sensor 120 does not need to repeat the environmental data and does not have direct access to any LoRaWAN Gateway, then the sensor 120 may transmit data from its own sensors over LoRa messages to one or more other sensors 120.

In an embodiment, the sensors 120 are organized or arranged according to a linear topology, e.g., as an array at spaced-apart intervals. This linear arrangement is aligned along a communication path, enabling efficient data collection and transmission. The linear topology of the sensors 120 facilitates optimal coverage and precise environmental data acquisition from multiple points, enhancing the overall effectiveness and accuracy of the system 100. Where data is incorporated along the linear topology discussed in the present embodiment, such data may be incorporated by adding or combining the data at each sensor 120 and then sending the added or combined data upstream, or by sending data upstream at each sensor 120 and adding or combining the data at the upstream sensor 120 (e.g., at the head-end sensor 120).

The foregoing discussion as to time synchronization may be equally applicable to the sensors 120 when organized or arranged according to the linear topology.

The term “linear topology” refers to an arrangement of sensors 120 where the sensors 120 are connected in a sequential manner, thereby forming a linear sequence akin to a chain or line. In an embodiment of this configuration, each node—excluding a head-end node and a tail-end node—is interconnected with two adjacent nodes: one immediately preceding it and one immediately succeeding it. Multiple intermediate nodes may be disposed between the head-end node and the tail-end node. Specifically, the head-end node establishes a connection with a first intermediate node. Conversely, the tail-end node connects exclusively with the last intermediate node. The linear configuration of the sensors 120 streamlines the flow of data along the communication path, significantly simplifying the process of data transmission and aggregation within the system 100.

The linear arrangement of the array of sensors 120 may present several notable advantages. The advantages include, but are not limited to, predictable and deterministic communication, streamlined routing and addressing, minimized interference, simplified network planning and deployment, reduced latency, and decreased power consumption. In this linear topology, the communication path between the sensors 120 is established in a fixed and predictable manner, fostering deterministic communication. This aspect is particularly advantageous in time-sensitive applications, such as real-time monitoring, control, and prediction systems, where reliable and timely data transmission is crucial.

Moreover, the linear arrangement of the sensors 120 simplifies the routing and addressing process, as each sensor 120 is configured to communicate only with its immediate neighbors. The setup reduces the overhead and complexity associated with network management, leading to more efficient operations. Additionally, the straight-line placement of the sensors 120 in the linear topology inherently reduces radio frequency interference between the sensors 120, enhancing the quality and reliability of communications. Furthermore, due to the proximity of communication between adjacent sensors 120, the power consumption within the linear topology is lower compared to more complex arrangements, where the sensors 120 may otherwise relay information across longer distances or through a plurality of intermediate sensors 120. The energy-efficient design is beneficial for sustainable and long-term environmental monitoring and prediction applications.

It will be understood that the sensors 120 may be organized or arranged in a further, other, or different topology, i.e., according to a topology that is not a mesh topology or a linear topology as hereinabove described.

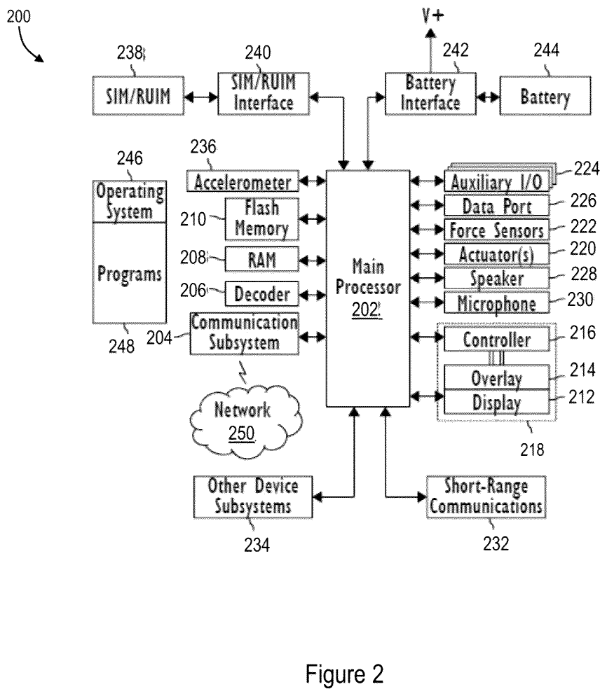

Referring now to FIG. 2, shown therein is a simplified block diagram of components of a device 200, according to an embodiment. The device 200 may correspond to any of the sensors 120 shown in FIG. 1. The device 200 may correspond to the server 140 shown in FIG. 1. The device 200 includes a processor 202 that controls the operations of the device 200. The processor 202 may be a low-power processing module in the sensor 120. Communication functions, including data communications, voice communications, or both may be performed through a wireless communication subsystem 204. The communication subsystem may be a wireless connection module in the sensor 120. The communication subsystem 204 may receive messages from, and send messages to, a wireless network 250. The wireless network may be the network 130 in FIG. 1. Data received by the device 200 may be decompressed and decrypted by a decoder 206.

The wireless network 250 may be any type of wireless network, including, but not limited to, data-centric wireless networks, voice-centric wireless networks, and dual-mode networks that support both voice and data communications.

The device 200 may be a battery-powered device and as shown includes a battery interface 242 for connecting to one or more rechargeable batteries 244. The device 200 may include a power supply assembly (not shown). The device 200 may further include one or more non-rechargeable batteries (not shown).

The processor 202 also interacts with additional subsystems such as a Random Access Memory (RAM) 208, a flash memory 210, a display 212 (e.g. with a touch-sensitive overlay 214 connected to an electronic controller 216 that together comprise a touch-sensitive display 218), an actuator assembly 220, one or more optional force sensors 222, an auxiliary input/output (I/O) subsystem 224, a data port 226, a speaker 228, a microphone 230, short-range communications systems 232 and other device subsystems 234.

In some embodiments, user-interaction with the graphical user interface may be performed through the touch-sensitive overlay 214. The processor 202 may interact with the touch-sensitive overlay 214 via the electronic controller 216. Information, such as text, characters, symbols, images, icons, and other items that may be displayed or rendered on a portable electronic device generated by the processor 202 may be displayed on the touch-sensitive display 218.

The processor 202 may also interact with an accelerometer 236 as shown in FIG. 2. The accelerometer 236 may be utilized for detecting direction of gravitational forces or gravity-induced reaction forces.

To identify a subscriber for network access according to the present embodiment, the device 200 may use a Subscriber Identity Module or a Removable User Identity Module (SIM/RUIM) card 238 inserted into a SIM/RUIM interface 240 for communication with a network (such as the wireless network 250). Alternatively, user identification information may be programmed into the flash memory 210 or performed using other techniques.

The device 200 also includes an operating system 246 and software components 248 that are executed by the processor 202 and which may be stored in a persistent data storage device such as the flash memory 210. Additional applications may be loaded onto the device 200 through the wireless network 250, the auxiliary I/O subsystem 224, the data port 226, the short-range communications subsystem 232, or any other suitable device subsystem 234.

For example, in use, a received signal such as a text message, an e-mail message, web page download, or other data may be processed by the communication subsystem 204 and input to the processor 202. The processor 202 then processes the received signal for output to the display 212 or alternatively to the auxiliary I/O subsystem 224. A subscriber may also compose data items, such as e-mail messages, for example, which may be transmitted over the wireless network 250 through the communication subsystem 204.

For voice communications, the overall operation of the device 200 may be similar. The speaker 228 may output audible information converted from electrical signals, and the microphone 230 may convert audible information into electrical signals for processing.

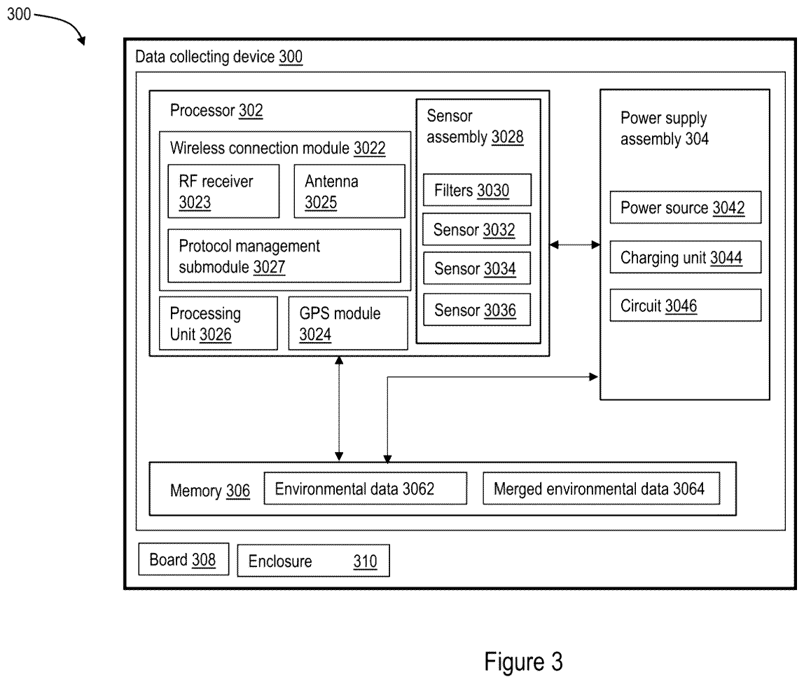

Referring now to FIG. 3, shown therein is a block diagram of a data collecting device 300 for early detection and monitoring of wildfires to facilitate real-time predictions on wildfire behaviour, according to an embodiment. The data collecting device 300 may be a sensor 120 of FIG. 1.

The data collecting device 300 includes a processor 302, a power supply assembly 304, a memory 306, a board 308 for providing circuits, and an enclosure 310 for providing protective cover to components of the device 300.

The processor 302 includes a wireless connection module 3022 for providing connectivity services, a global positioning system (GPS) module 3024 for providing location information, a processing unit 3026 to execute instructions, and a sensor assembly 3028 including a plurality of sensors 3032-3036. The sensors 3032-3036 may be connected to a plurality of filters 3030 to improve accuracy and reliability of the measured data. The processing unit 3026 may be configured as a low-power processing module.

The power supply assembly 304 may include a power source 3042 to store and provide electrical power, a charging unit 3044 to charge the power source, and a circuit 3046 to provide control of the electrical current. The charging unit 3044 may include a solar charging apparatus including a solar panel.

The wireless connection module 3022 may be configured to connect the data collecting device 300 to the wildfire detection network 130 of FIG. 1 to enable wireless data transmission and reception therebetween. The wireless connection module 3022 may connect to the network gateway and the sensors 120 in the wildfire detection network 130.

The wireless connection module 3022 may include a radio frequency receiver 3023 to transmit and receive signals at specific radio frequencies and at specific time intervals. The wireless connection module 3022 may be configured to convert received radio frequency signals into digital data that may be processed by the low-power processing unit 3026. The wireless connection module 3022 includes an antenna 3025 configured to convert the signals into electromagnetic waves for transmission. The wireless connection module 3022 may be configured to connect the components within the data collecting device 300, including the processor 302, sensor assembly 3028, power supply assembly 304, and memory 306.

In an embodiment, in addition to the wireless communication module 3022, the data collecting device 300 includes a wired communication module (not shown) suitable to communicate with other data collecting devices 300 and the network gateway over a hybrid network 130 as discussed in relation to FIG. 1. Alternatively, a wired network 130 may be provided and the data collecting device 300 may include a wired communication module (not shown) configured to communicate with other data collecting devices 300 and the network gateway.

The wireless connection module 3022 is configured to transmit data collected by sensors 3032-3036 to the network gateway or other data collecting devices 300 within the wildfire detection system 100. The wireless connection module 3022 may connect the data collecting device 300 to the network 130. The wireless connection module 3022 may also provide services including packet formation, error checking, encryption and addressing. The wireless connection module 3022 may provide network management tasks, including discovery of data collecting devices 300, configuration of the wildfire detection network 130, and maintaining connections with other data collecting devices 300.

The wireless connection module 3022 may also be configured to manage communication protocols such as Wi-Fi™, Zigbee™, Bluetooth™, LoRa and LoRaWAN to facilitate secure data transmission with low power consumption. In an embodiment, the wireless connection module 3022 is configured as a LoRa wireless connection module and/or or a LoRaWAN connection module.

The data collecting device 300 is configured to operate in a plurality of modes of operation or data transmission. The plurality of modes include LoRa end-node, LoRaWAN end-node, LoRa repeater mode, and LoRa to LoRaWAN mode. The modes of operation may represent various interoperability operations and utilities such as low battery consumption (LoRa), long-distance communication (LoRaWAN), extending communications (repeater mode), and interoperability between LoRa and LoRaWAN protocols, respectively. The protocol management submodule 3027 in the data collecting device 300 may automatically select the mode based on the location of the device 300 in the network 130. The protocol management submodule 3027 may automatically select the transmission mode based on the protocol through which the data is received. For example, a LoRa mode may be selected on receiving a LoRa message or a LoRaWAN mode may be selected on receiving a LoRaWAN message.

LoRa (Long Range) includes a digital wireless data communication technology that utilizes low frequency radio frequency bands and modulation techniques to provide long-range communication and low power consumption. The LoRa protocol may address the physical layer of communication and format the data sent and received between the data collecting devices 300. LoRaWAN (Long Range Wide Area Network) includes a standardized protocol built upon LoRa technology providing higher abstraction. The LoRaWAN protocol may include both the communication protocol and system architecture for a LoRa-based network to enable efficient, secure, scalable data transmission between data collecting devices 300 and network gateways.

The wireless connection module 3022 includes a protocol management submodule 3027. To enable low-power functionality, the protocol management submodule 3027 is configured to provide protocol management for LoRa and LoRaWAN data transmission protocols, including providing services for each protocol. The services may include packet formation, error checking, device detection, addressing, and encryption. The protocol management submodule 3027 formats the data collected by the sensors into packets in accordance with LoRa or LoRaWAN specifications based on requirements of the network 130. Such formatting includes adding headers, metadata and control information for proper routing and processing by the network gateway or other devices of the system 100. The LoRaWAN protocol may rely on error checking mechanisms such as Cyclic Redundancy Check (CRC) or Forward Error Correction (FEC) to detect and correct errors during data transmission. The protocol management submodule 3027 may be configured to implement the error checking and provide data integrity and reliability information. Furthermore, the LoRaWAN protocol may utilize device identifiers (DevEUI) and network identifiers (NetID) to address data collecting devices on the wildfire detection network 130. The protocol management submodule 3027 may be configured to manage an addressing scheme therefor and to provide data transmission between data collecting devices 300 and routing within the system 100. Furthermore, the LoRaWAN protocol may utilize an adaptive data rate mechanism that adjusts data rates and transmission power of the devices 300 based on distance of each device 300 from the gateway and further based on conditions of the network 130. The protocol management submodule 3027 may be configured to manage this feature, optimizing energy consumption and network capacity.

To provide security services, the protocol management submodule 3027 may be configured to implement security features of LoRaWAN or LoRa security features. The protocol management submodule 3027 may be configured to implement encryption mechanisms such as Advanced Encryption Standard (AES) with a 128-bit key to protect sensitive information from unauthorized access.

The protocol management submodule 3027 may be configured to perform network and protocol related tasks, including device activation and joining procedures and acknowledging and processing messages sent from the network gateway.

The protocol management submodule 3027 may also provide for and/or enable optimized power consumption to save energy and extend battery life of each device 300. Such optimized power consumption includes time-synchronization and entering low-power modes when each device 300 is not actively transmitting or receiving data. The protocol management submodule 3027 may be configured to operate the time synchronization with respect to each of sensors 3032-3036. The sensors 3032-3036 and processing unit 3026 may be optimized for reduced power consumption through time synchronization techniques. the Techniques including duty cycling, time-slotted communication, coordinated sensing, power-efficient routing, and reduced idle listening may be used. The processing unit 3026 may be configured to activate data collection in the sensors 3032-3036 at predefined time schedules and enter low-power inactive modes outside of the predefined time schedules and/or cause the sensors 3032-3036, the radio-frequency (RF) receiver 2023, and the antenna 3025 to enter low-power inactive modes outside the predefined time schedules. Similarly, the protocol management submodule 3027 may be configured to receive and transmit environmental data at predefined time schedules and alternatively enter low-power inactive modes.

The processing unit 3026 may be configured as a low-power processing module. The low-power processing module 3026 may be connected to the wireless connection module 3022 and other components of the data collecting device 300. The low-power processing module 3026 may be configured to receive data from the sensor assembly 3028 and the GPS module 3024. The low-power processing module 3026 may process or merge the data and communicate the processed data to the network 130 through the wireless connection module 3022.

The low-power processing module 3026, may be configured as low-power computing systems configured to execute instructions stored in the memory 306 or on other similar storage devices. The instructions may include one or more separate programs, which may comprise an ordered listing of executable instructions for implementing logical functions. The low-power processing module 3026 may control the execution of other computer programs and provides scheduling, input-output control, file and data management, memory management, and communication control and related services.

The filters 3030 may be used to provide protection to the plurality of sensors 3032-3036 and enhance performance, improve measurement accuracy, and protect the sensors 3032-3036 from interfering signals. The filters 3030 may include bandpass filters to allow a specific wavelength range of light to enter the sensors, neutral density filters to attenuate the intensity of light entering the sensor, chemical filters to allow selective detection of gases, particulate filters to prevent solid particles, dust, or aerosols from interfering with the sensing process, hydrophobic filters to prevent the ingress of water vapor or liquid water, moisture control filters to control humidity levels, and/or temperature control filters.

Data sensed by the sensors 3032-3036 is stored in the memory 306 as environmental data 3062. The environmental data 3062 may thereafter be transmitted to the low-power processing module 3026. Detection by the sensors 3032-3036 is configured to collect and monitor the environmental data 3062 to facilitate detection of conditions suggesting wildfire, including environmental dynamics, and the microclimate of an active wildfire to enable accurate real-time predictions as to wildfire behaviour. The conditions may include detecting, identifying, and measuring the environmental data 3062 in proximity to the sensors 3032-3036 such as chemicals, gases, and physical conditions such as temperature and humidity. When environmental data 3062 received at a device 300 from a different device 300 is merged with environmental data 3062 collected at the device 300, such merged data is stored in the memory 306 as merged data 3064. The plurality of sensors 3032 to 3036 are configured for low power consumption and provide ultra-early wildfire detection using time synchronization as hereinabove described. The sensors 3032-3036 detect environmental conditions, such as the presence/absence of elements associated with fire such as carbon dioxide, carbon monoxide, nitrogen dioxide, temperature, and/or humidity. The conditions may include temperature, humidity, smoke, or infrared radiation. A temperature sensor (e.g., the sensor 3032) may include a thermistor or thermocouple to measure the ambient temperature in a surrounding environment. When the temperature sensor 3032 records a sudden increase in temperature or once a predefined threshold is exceeded, this may indicate fire activity. A humidity sensor (e.g., the sensor 3034) may detect air humidity and moisture levels in the environment close to the sensor. A low humidity level may indicate a risk of wildfire. Such risks of wildfire include the risk that a wildfire will spread to an adjacent area, i.e., indications of wildfire behaviour or indicia to enable predicting wildfire behaviour in real time.

A smoke sensor (e.g., the sensor 3036) may include optical, photoelectric, ionization, or other types of sensors configured to detect the presence of smoke particles in the air. The presence of smoke may indicate a wildfire or provide indications as to predicted wildfire behaviour. Further, a gas sensor (e.g., the sensor 3036) may detect the presence of combustion gases. The gas sensor 3036 may be configured to detect carbon monoxide (CO) or volatile organic compounds (VOCs) that may be produced during a fire. Humidity data may be combined with other sensor data to assess the likely behaviour of the wildfire. The sensors 3032-3036 may further detect wind speed and direction.

The data collecting device 300 includes a power supply assembly 304 to provide electrical power to the components of the data collecting device 300.

The power supply assembly 304 includes a power source 3042 to store and provide electrical power, a charging unit 3044 to charge the power source, and a circuit 3046 to provide control of the electrical current. The charging unit 3044 may include a solar charging apparatus including a solar panel.

In an embodiment, the power source 3042 includes a plurality of batteries. The power source includes a non-rechargeable and a rechargeable battery. The rechargeable battery may be a solar cell. The plurality of batteries may include rechargeable batteries and high-capacity non-rechargeable batteries. The power collection apparatus may include a solar cell for charging the plurality of batteries. The rechargeable battery may serve as a first power source until an energy level of the rechargeable battery reaches a predetermined limit. The non-rechargeable battery may serve as a second power source when the energy level is at the predetermined limit until the rechargeable battery is recharged so that the energy level is not at the predetermined limit.

The power management circuit 3046 may be configured as a smart power management circuit. The smart power management circuit 3046 may recharge a battery of the charging unit 3044 until the battery capacity drops below a threshold (e.g., 30%). At that point, the circuit 3046 may switch to a high-capacity non-rechargeable battery until the rechargeable battery recharges to a predetermined threshold (80%). This feature reduces power consumption of the device 300. Furthermore, the circuit 3046 may optimize warm-up times of the sensors 3042-3046 and intervals in data transmission.

The data collecting device 300 may be physically enclosed in a protective enclosure 310.

The board 308 may have a modular design for the board 308. The board 308 may be configured to provide for the sensors 3042-3046 to be integrated into or removed from the device 300. The board 308 may be configured to receive the filter 3030. In an embodiment, the filter 3030 is a removable gas filter.

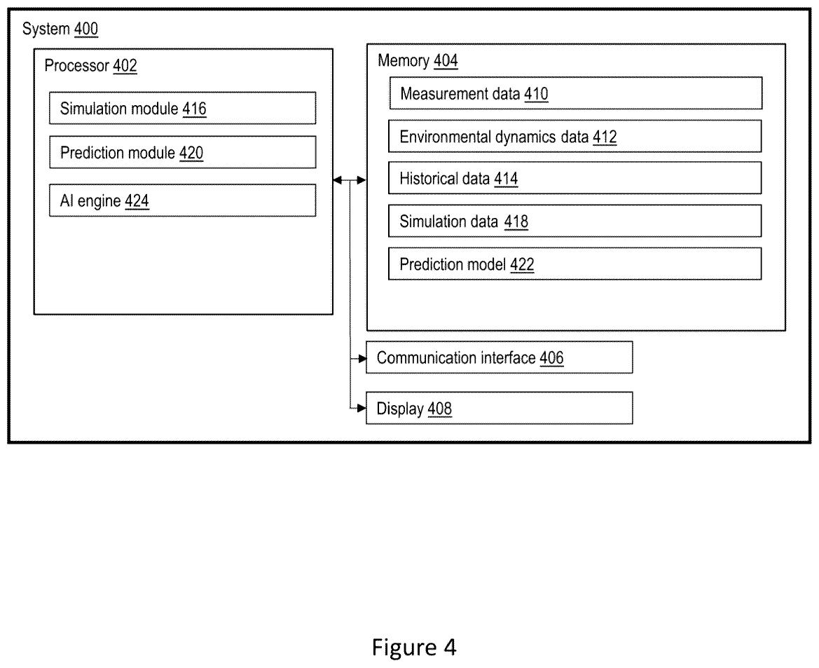

Referring now to FIG. 4, shown therein is a block diagram of a system 400 for predicting wildfire behaviour in real time. The system 400 may be the analysis server 140 of FIG. 1.

The system 400 includes a memory 404 for storing data and a processor 402 for processing the data and making predictions as to wildfire behaviour. The system 400 further includes a communication interface 406 for interacting with a user and a display 408.

The system 400 receives measurement data 410 sensed by sensors (such as the sensors 120 of FIG. 1) or otherwise provided as input and stored in the memory 404. The system 400 applies artificial intelligence to the measurement data 410 to make specific predictions as to wildfire behaviour.

The memory 404 further stores environmental dynamics data 412, such as wind speed perturbations to account for the complex interaction between wildfires and their surrounding environment.

The memory 404 further stores historical data 414. The historical data 414 includes various ignition points selected based on proximity to high-risk areas such as power lines, railways, villages, roads, and campsites.

The processor 402 includes a simulation module 416 for generating simulation data 418 pertaining to wildfire behaviour. For example, the simulation module 416 may, responsive to measurement data 410 being provided to the system 400 and/or using the environmental dynamics data 412 and/or the historical data 414, generate simulation data 418 pertaining to an active wildfire. The simulation data 418 is stored at the memory 404. The simulation data 418 may include one or more simulated behaviours of an active wildfire at a future or hypothetical point in time, e.g., simulating the wildfire as having spread to a location adjacent an actual location of the wildfire as determined in the measurement data 410.

The selection of ignition points in the historical data 414 enables preemptive analysis and planning with respect to generating and storing the simulation data 418, which allows for the identification of areas at a higher risk of wildfire ignition or spread. The foregoing further advantageously allows the system 400 to study how wildfires start and spread, further improving the foregoing analysis. The foregoing further advantageously allows the system 400 to simulate the implementation of targeted prevention and mitigation strategies.

The processor 402 further includes a prediction module 420 for generating a prediction model 422, stored in the memory 404, as to wildfire behaviour at a future or hypothetical time.

The prediction model 422 may correspond to or produce one or more specific predictions about an active wildfire, e.g., characteristics or microdynamics of the wildfire, new fire spots corresponding to abnormal data, areas at higher risk of a fire, how a wildfire may start or spread, and targeted strategies for mitigating, extinguishing, or preventing wildfires.

The processor 402 further includes an artificial intelligence (AI) engine 424 to enable the prediction model 422 to answer specific questions and learn from the simulation data 418, its own specific predictions, or otherwise.

Output from the AI engine 424 may be received and stored by the system 400 in order to further and iteratively improve the system 400, for example causing the simulation data 418 and/or the prediction model 422 to become more accurate and/or causing the simulation module 416 and/or the prediction module 420 to operate more efficiently or more quickly or otherwise improving the real-time performance of the system 400.

The AI engine 424 is advantageously able to learn and improve as the system 400 performs predictions. For example, the system 400 is configured to detect new fire spots through abnormal changes detected in the measurement data 410. Because the system 400 is configured to detect the new fire spots, predictions as to spread rate, direction, and fireline intensity of wildfires sensed by the system 400 may be continuously updated. As the prediction module 420 generates and refines the prediction model 422 (i.e., generates more predictions), the system 400 becomes even more accurate and responsive.

Because wildfires may create their own microclimate (e.g., changing wind speed, air heating), the system 400 may further incorporate the environmental dynamics data 412 into the prediction model 422 to predict, in real time, where a wildfire is heading. The measurement data 410 may be used as secondary confirmation of real-time predictions and/or to improve the prediction model 422.

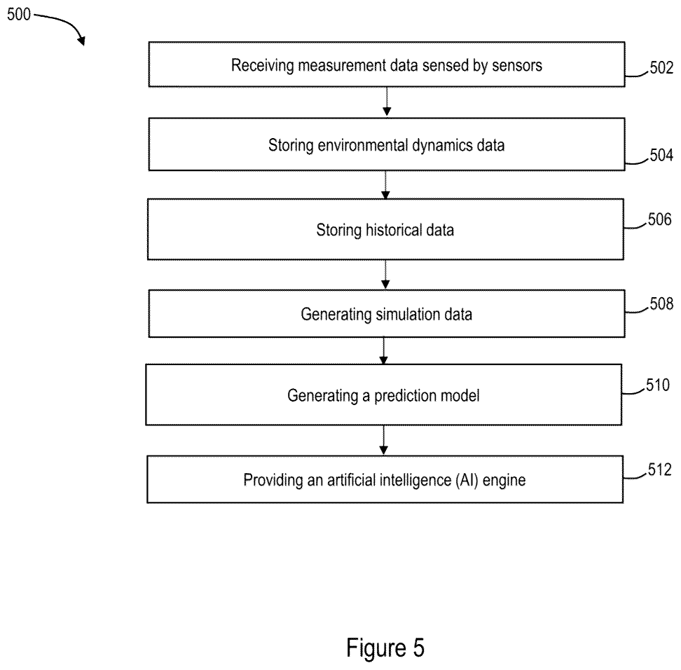

Referring now to FIG. 5, shown therein is a flow diagram of a method 500 for predicting wildfire behaviour in real time, according to an embodiment. The method 500 may be implemented by the system 100 of FIG. 1 or the system 400 of FIG. 4. The method 500 may be implemented using the data collecting devices 300 of FIG. 3 as sensors.

At 502, the method 500 includes receiving measurement data sensed by sensors (such as the sensors 120 of FIG. 1 or the data collecting devices 300 of FIG. 3).

At 504, the method 500 further includes storing environmental dynamics data, such as wind speed perturbations, to account for the complex interaction between wildfires and their surrounding environment.

At 506, the method 500 further includes storing historical data. The historical data may include various ignition points selected based on proximity to high-risk areas such as power lines, railways, villages, roads, and campsites.

At 508, the method 500 further includes generating simulation data pertaining to wildfire behaviour based at least in part on one or more of the measurement data, the environmental dynamics data, and the historical data.

At 510, the method 500 further includes generating a prediction model as to wildfire behaviour at a future or hypothetical time, based at least in part on one or more of the measurement data, the environmental dynamics data, and the historical data.

The prediction model may correspond to or produce one or more specific predictions about an active wildfire, e.g., characteristics or microdynamics of the wildfire, new fire spots corresponding to abnormal data, areas at higher risk of a fire, how a wildfire may start or spread, and targeted strategies for mitigating, extinguishing, or preventing wildfires.

At 512, the method 500 further includes providing an artificial intelligence (AI) engine to enable the prediction model to answer specific questions and learn from the simulation data, its own specific predictions, or otherwise.

While the above description provides examples of one or more apparatus, methods, or systems, it may be appreciated that other apparatus, methods, or systems may be within the scope of the claims as interpreted by one of skill in the art.

What is claimed is the systems, methods, and devices as generally and specifically described herein:

1. A system for predicting behaviour of a wildfire in real time, the system comprising:
a first sensor subsystem for measuring geographical data of a first area, the first sensor subsystem comprising one or more data collecting devices;
a second sensor subsystem for measuring environmental data of the first area, the second sensor subsystem comprising one or more data collecting devices;
an analysis server, the analysis server comprising:
a memory for storing environmental dynamics data and historical data;
a simulation module for generating simulation data pertaining to the behaviour of the wildfire responsive to receiving the geographical data from the first sensor subsystem, the environmental data from the second subsystem, and/or the environmental dynamics data or the historical data;
a prediction module for generating a prediction model for predicting the behaviour of the wildfire at a future or hypothetical point in time by incorporating the geographical data, the environmental data, the environmental dynamics data, and/or the historical data into the prediction model; and
an artificial intelligence (AI) engine configured to enable the prediction module to answer specific questions and learn from the simulation data and/or the predicted behaviour of the wildfire;
wherein output of the AI engine is stored at the analysis server to iteratively improve the analysis server.

2. The system of claim 1, wherein the first area is an area in which the wildfire has occurred.

3. The system of claim 1, wherein the environmental dynamics data comprises wind data including wind speed perturbations, temperature data, precipitation data, and sunshine intensity data.

4. The system of claim 1, wherein the historical data comprises ignition points selected based on proximity to high-risk areas including power lines, railways, villages, roads, and campsites.

5. The system of claim 1, wherein the simulation data comprises one or more simulated behaviours of the wildfire at the future or hypothetical point in time; and wherein the one or more simulated behaviours comprise the wildfire spreading to a second area adjacent the first area.

6. (canceled)

7. The system of claim 1, wherein the prediction model generates a specific prediction as to the behaviour of the wildfire at the future or hypothetical point in time; and wherein the specific prediction comprises a prediction as to any one or more of characteristics or microdynamics of the wildfire, new fire spots of the wildfire, areas at higher risk of another wildfire, whether and how the wildfire spreads at the future or hypothetical point in time, and the efficacy of one or more strategies for mitigating or extinguishing the wildfire or preventing wildfires.

8. (canceled)

9. (canceled)

10. (canceled)

11. The system of claim 10, wherein each data collecting device includes a wireless communication module, and wherein the wireless communication module is configured to operate in any one of a plurality of operation modes including a LoRa end-node, a LoRaWAN end-node, a LoRa repeater mode, and a LoRa to LoRaWAN mode based on the received network protocol of another data collecting device; and wherein each data collecting device is configured to automatically select a network protocol from a plurality of network protocols based on a location of the data collecting device and/or a received network protocol received from another data collecting device.

12. (canceled)

13. (canceled)

14. A method for predicting behaviour of a wildfire in real time, the method comprising:
measuring, with a first sensor subsystem, geographical data of a first area, the first sensor subsystem comprising one or more data collecting devices;
measuring, with a second sensor subsystem, environmental data of the first area, the second sensor subsystem comprising one or more data collecting devices;
storing environmental dynamics data and historical data;
generating simulation data pertaining to the behaviour of the wildfire based at least in part on the geographical data from the first sensor subsystem, the environmental data from the second subsystem, and/or the environmental dynamics data or the historical data;
generating a prediction model for predicting the behaviour of the wildfire at a future or hypothetical point in time by incorporating the geographical data, the environmental data, the environmental dynamics data, and/or the historical data into the prediction model; and
providing an artificial intelligence (AI) engine configured to enable the prediction module to answer specific questions and learn from the simulation data and/or the predicted behaviour of the wildfire;
wherein output of the AI engine is used to iteratively improve the simulation data and/or the prediction model.

15. (canceled)

16. (canceled)

17. (canceled)

18. The method of claim 14, wherein the simulation data comprises one or more simulated behaviours of the wildfire at the future or hypothetical point in time; and wherein the historical data comprises ignition points selected based on proximity to high-risk areas including power lines, railways, villages, roads, and campsites.

19. The method of claim 18, wherein the one or more simulated behaviours comprise the wildfire spreading to a second area adjacent the first area.

20. The method of claim 14, wherein the prediction model generates a specific prediction as to the behaviour of the wildfire at the future or hypothetical point in time.

21. The method of claim 20, wherein the specific prediction comprises a prediction as to any one or more of characteristics or microdynamics of the wildfire, new fire spots of the wildfire, areas at higher risk of another wildfire, whether and how the wildfire spreads at the future or hypothetical point in time, and the efficacy of one or more strategies for mitigating or extinguishing the wildfire or preventing wildfires.

22. (canceled)

23. (canceled)

24. The method of claim 14, wherein each data collecting device includes a wireless communication module, and wherein the wireless communication module is configured to operate in any one of a plurality of operation modes including a LoRa end-node, a LoRaWAN end-node, a LoRa repeater mode, and a LoRa to LoRaWAN mode based on the received network protocol of another data collecting device; and wherein the method further includes selecting automatically, by each data collecting device, a network protocol from a plurality of network protocols based on a location of the data collecting device and/or a received network protocol received from another data collecting device.

25. (canceled)

26. (canceled)

27. An analysis server for predicting behaviour of a wildfire in real time, the server receiving geographical data of a first area from a first sensor subsystem comprising one or more data collecting devices and receiving environmental data of the first area from a second sensor subsystem comprising one or more data collecting devices, the server comprising:
a memory for storing environmental dynamics data and historical data;
a simulation module for generating simulation data pertaining to the behaviour of the wildfire responsive to receiving the geographical data from the first sensor subsystem, the environmental data from the second subsystem, and/or the environmental dynamics data or the historical data;
a prediction module for generating a prediction model for predicting the behaviour of the wildfire at a future or hypothetical point in time by incorporating the geographical data, the environmental data, the environmental dynamics data, and/or the historical data into the prediction model; and
an artificial intelligence (AI) engine configured to enable the prediction module to answer specific questions and learn from the simulation data and/or the predicted behaviour of the wildfire;
wherein output of the AI engine is stored at the analysis server to iteratively improve the analysis server.

28. (canceled)

29. (canceled)

30. (canceled)

31. The server of claim 27, wherein the simulation data comprises one or more simulated behaviours of the wildfire at the future or hypothetical point in time; and wherein the one or more simulated behaviours comprise the wildfire spreading to a second area adjacent the first area.

32. (canceled)

33. The server of claim 27, wherein the prediction model generates a specific prediction as to the behaviour of the wildfire at the future or hypothetical point in time; and wherein the specific prediction comprises a prediction as to any one or more of characteristics or microdynamics of the wildfire, new fire spots of the wildfire, areas at higher risk of another wildfire, whether and how the wildfire spreads at the future or hypothetical point in time, and the efficacy of one or more strategies for mitigating or extinguishing the wildfire or preventing wildfires.

34. (canceled)

35. (canceled)

36. The server of claim 27, wherein each data collecting device includes a sensor assembly, wherein the sensor assembly includes a plurality of sensors configured to detect the environmental data, the environmental data relating to any one or more of carbon dioxide, carbon monoxide, nitrogen dioxide, temperature, and humidity, and wherein the sensor assembly includes a filter configured to improve measurement accuracy, the filter configured as any one or more of a bandpass filter, a neutral density filter, a chemical filter, and a particulate filter.

37. The server of claim 27, wherein each data collecting device includes a wireless communication module, and wherein the wireless communication module is configured to operate in any one of a plurality of operation modes including a LoRa end-node, a LoRaWAN end-node, a LoRa repeater mode, and a LoRa to LoRaWAN mode based on the received network protocol of another data collecting device.

38. The server of claim 27, wherein each data collecting device includes a power supply assembly configured to provide electrical power to the respective data collecting device, the power supply assembly including a power source and a power management circuit, wherein the power source includes a rechargeable battery and a non-rechargeable battery, the rechargeable battery serves as a first power source until an energy level of the rechargeable battery reaches a predetermined limit according to the power management circuit, and the non-rechargeable battery serves as a second power source when the energy level is at the predetermined limit.

39. The server of claim 27, wherein each data collecting device is configured to automatically select a network protocol from a plurality of network protocols based on a location of the data collecting device and/or a received network protocol received from another data collecting device.
